(19) United States
(12) Patent Application Publication
(10) Pub. No.: US 2007/0021997 A1
(43) Pub. Date: Jan. 25, 2007

(54) System and method for efficient optimization of meeting time selection

(75) Inventors: Kent Fillmore Hayes, JR., Chapel Hill, NC (US); Kenneth Alexander McKethan, JR., Dunn, NC (US); Paul Franklin McMahan, Apex, NC (US)

Correspondence Address: DUKE W. YEE, YEE & ASSOCIATES, P.C., P.O. BOX 802333, DALLAS, TX, 75380, US

(73) Assignee: International Business Machines Corporation, Armonk, NY (US)

(21) Appl. No.: 11/186,549

(22) Filed: Jul. 21, 2005

(51) Int. Cl. G06F 15/02

(52) U.S. Cl. 705/9

(57) ABSTRACT

The present invention provides a computer implemented method, system, and computer usable code of optimizing meeting attendance. Input is received from multiple meeting invitees to generate a set of profiles for the meeting invitees. The input includes attendance information for each of the plurality of meeting invitees. When a proposed meeting time is selected, a set of scores is generated for the proposed meeting using the set of profiles for the meeting invitees. The set of scores indicates a likelihood of attendance for each of the meeting invitees for the proposed meeting.

### BACKGROUND OF THE INVENTION

1. Field of the Invention

The present invention relates generally to data processing and, in particular, to global meeting planning. Still more particularly, the present invention provides a computer implemented method, system, and computer usable code for maximizing meeting attendance based on an individual invitee's profile score and overall meeting score computed using the input of invitees and a meeting planner.

2. Description of the Related Art

Due to company expansion and globalization, interaction in the global workplace has become more common in recent years. Many meeting planners are required to effectively plan meetings with team members that may be in different geographic locations, in different time zones, and on different schedules. In some cases the meeting planner must plan a series of meetings to ensure progress, coordination, and communication regarding relevant projects.

Even with networked computer systems, scheduling meetings and teleconferences typically involves a series of iterative steps before the planner or coordinator finally arrives at a time that is reasonably convenient for most or all meeting invitees. As defined herein, a meeting is any coordinated gathering, collaboration, teleconference, or communication of individuals, electronic or otherwise.

In many cases, planning a meeting involves more guessing and trial and error than actual planning. This process can be especially difficult, tedious, time consuming, error-prone, and frustrating in a global workplace because of factors including different time zones, local customs, religious and cultural practices, work habits, personal preferences, and work loads to name a few. In many cases, these factors are exacerbated when the normal work hours of global meeting invitees do not coincide for a potential meeting.

Planning a meeting can be especially difficult when there are varying degrees of importance assigned to each invitee's presence. For example, in many cases, even if the majority of invitees are able at a specific time for a teleconference if one key supervisor or manager is unavailable, the teleconference cannot effectively be held at that time. Despite a meeting planner's best efforts, many hours may be spent to come to a meeting consensus where only some of the meeting invitees can or may attend.

### BRIEF SUMMARY OF THE INVENTION

The present invention provides a computer implemented method, system, and computer usable code of optimizing meeting attendance. Input is received from multiple meeting invitees to generate a set of profiles for the meeting invitees. The input includes attendance information for each of the plurality of meeting invitees. When a proposed meeting time is selected, a set of scores is generated for the proposed meeting using the set of profiles for the meeting invitees. The set of scores indicates a likelihood of attendance for each of the meeting invitees for the proposed meeting.

### BRIEF DESCRIPTION OF THE SEVERAL VIEWS OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a pictorial representation of a network of data processing systems in which the present invention may be implemented;

FIG. 2 is a block diagram of a data processing system in which the present invention may be implemented;

FIG. 3 is a block diagram that illustrates the manner in which information is managed in accordance with a preferred embodiment of the present invention;

FIG. 4 depicts an example screen of display for receiving meeting planner input in a meeting optimization environment in accordance with an illustrative embodiment of the present invention;

FIG. 5 depicts an example screen of display for receiving input from a meeting invitee in a meeting optimization environment in accordance with an illustrative embodiment of the present invention;

FIG. 6 depicts an example screen of display for maximizing meeting attendance according to an individual score and overall score in a meeting optimization environment in accordance with an illustrative embodiment of the present invention;

FIG. 7 is a flowchart illustrating exemplary steps for a computer implemented method and computer usable code for efficient optimization of a meeting time selection in accordance with an illustrative embodiment of the present invention;

FIG. 8 is a flowchart illustrating exemplary steps for a computer implemented method and computer usable code for efficient optimization of a meeting time selection in accordance with an illustrative embodiment of the present invention; and

FIG. 9 is a flowchart illustrating exemplary steps for a computer implemented method and computer usable code for efficient optimization of meeting time selection in accordance with an illustrative embodiment of the present invention.

### DETAILED DESCRIPTION OF THE INVENTION

The different embodiments of the present invention relate to a computer implemented method, system, and computer usable code for meeting planning. The different aspects of the present invention allow a meeting planner to maximize meeting attendance based on input from meeting invitee's and a meeting planner. This information is used to compile an individual score for each invitee and an overall meeting score based on the meeting invitee's scores. The individual and overall meeting score is associated with the likelihood that an invitee or all invitees will be able to attend a meeting at a specified time. The individual or individuals organizing, supervising, managing, and/or coordinating a meeting will hereinafter be referred to generally as the meeting planner.

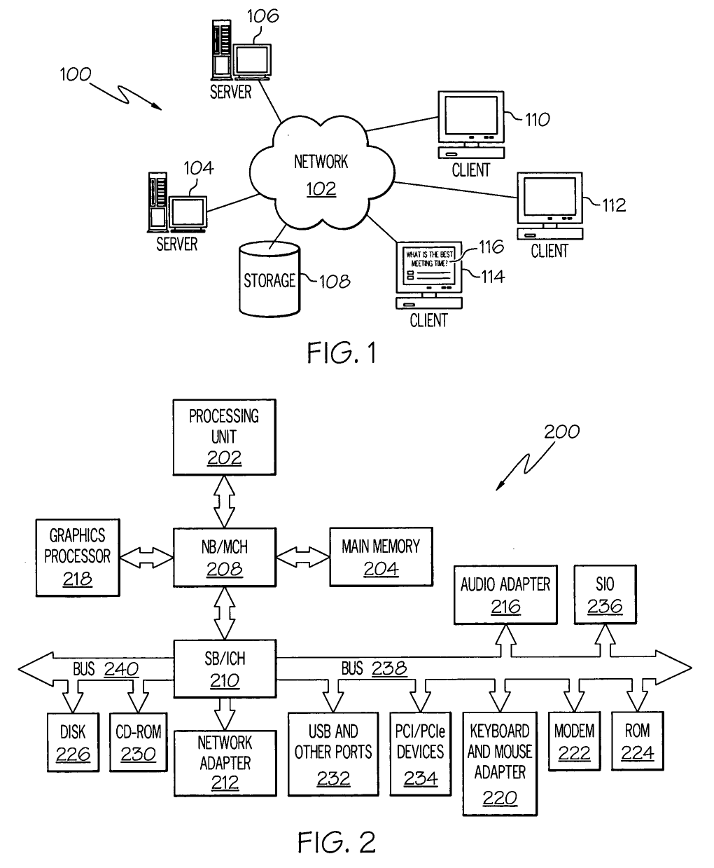

The different embodiments of the present invention may be embodied in computer usable code or software program application that employs the systems and computer implemented methods herein described to optimize meeting attendance. FIGS. 1-2 are provided as exemplary diagrams of data processing environments in which embodiments of the present invention may be implemented. It should be appreciated that FIGS. 1-2 are only exemplary and are not intended to assert or imply any limitation with regard to the environments in which aspects or embodiments of the present invention may be implemented. Many modifications to the depicted environments may be made without departing from the spirit and scope of the present invention.

With reference now to the figures, FIG. 1 depicts a pictorial representation of a network of data processing systems in which aspects of the present invention may be implemented. Network data processing system 100 is a network of computers in which embodiments of the present invention may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. These clients 110, 112, and 114 may be, for example, personal computers or network computers accessible by users. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

The servers 104, 106 and storage unit 108 preferably allow user information and profiles to be stored therein accessible by the individual invitee and the meeting planner. Each invitee preferably only has access to their own profile and inputs they have entered or to which the meeting planner has given them authorization to access. Databases stored on the servers 104, 106 and storage unit 108 may allow the invitee and meeting planner to more quickly enter information after initially being established.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN).

FIG. 1 is intended as an example, and not as an architectural limitation for different embodiments of the present invention. In accordance with a preferred embodiment of the present invention, any of the clients 108, 110, or 112 may be a remote locations running the meeting optimization application. They may be in different physical locations and across different time zones. The clients 108, 110, 122 may be the meeting planner(s) or invitees. The meeting optimization application receives information from each meeting planner and invitee through an input device and sends the information through the network 102 to be stored in the storage 108 or on the servers 104, 106.

Data processing systems are capable of communicating information to users in many formats, including: text, graphics, sounds, animated graphics, synthesized speech, and video. The meeting optimization application employs a data processing system to combine such information formats into a coherent and comprehensive presentation to the user.

As a result of the increasing complexity of data processing systems and with the introduction of multimedia presentations, attempts have been made to simplify the interface between a user and the large amounts of data present within a modern data processing system. One example of an attempt to simplify the interface between a user and a data processing system is the utilization of a so-called graphic user interface (GUI) 116 to provide an intuitive and graphical interface between the user, such as the client 114, and the data processing system. A GUI 116 is an interface system, including devices, by which a user interacts with a system, system components, and/or system applications via windows or view ports, icons, menus, pointing devices, electronic pens, touch screens, and other input devices. Information may be both input and viewed by the meeting planner and meeting invitees through the GUI 116.

With reference now to FIG. 2, a block diagram of a data processing system is shown in which aspects of the present invention may be implemented. Data processing system 200 is an example of a computer, such as server 104 or client 110 in FIG. 1, in which computer usable code or instructions implementing the processes for embodiments of the present invention may be located.

In the depicted example, data processing system 200 employs a hub architecture including north bridge and memory controller hub (MCH) 208 and south bridge and input/output (I/O) controller hub (ICH) 210. Processing unit 202, main memory 204, and graphics processor 218 are connected to north bridge and memory controller hub 208. Graphics processor 218 may be connected to north bridge and memory controller hub 208 through an accelerated graphics port (AGP).

In the depicted example, local area network (LAN) adapter 212, audio adapter 216, keyboard and mouse adapter 220, modem 222, read only memory (ROM) 224, hard disk drive (HDD) 226, CD-ROM drive 230, universal serial bus (USB) ports and other communications ports 232, and PCI/PCIe devices 234 connect to south bridge and I/O controller hub 210 through bus 238. PCI/PCIe devices may include, for example, Ethernet adapters, add-in cards and PC cards for notebook computers. PCI uses a card bus controller, while PCIe does not. ROM 224 may be, for example, a flash binary input/output system (BIOS).

Hard disk drive 226 and CD-ROM drive 230 connect to south bridge and I/O controller hub 210 through bus 240. Hard disk drive 226 and CD-ROM drive 230 may use, for example, an integrated drive electronics (IDE) or serial advanced technology attachment (SATA) interface. Super I/O (SIO) device 236 may be connected to south bridge and I/O controller hub 210.

An operating system runs on processing unit 202 and coordinates and provides control of various components within data processing system 200 in FIG. 2. As a client, the operating system may be a commercially available operating system such as Microsoft® Windows® XP (Microsoft and Windows are trademarks of Microsoft Corporation in the United States, other countries, or both). An object-oriented programming system, such as the Java™ programming system, may run in conjunction with the operating system and provides calls to the operating system from Java programs or applications executing on data processing system 200 (Java is a trademark of Sun Microsystems, Inc. in the United States, other countries, or both).

As a server, data processing system 200 may be, for example, an IBM eServer™ pSeries® computer system, running the Advanced Interactive Executive (AIX®) operating system or LINUX operating system (eServer, pSeries and AIX are trademarks of International Business Machines Corporation in the United States, other countries, or both while Linux is a trademark of Linus Torvalds in the United States, other countries, or both). Data processing system 200 may be a symmetric multiprocessor (SMP) system including a plurality of processors in processing unit 202. Alternatively, a single processor system may be employed.

Instructions for the operating system, the object-oriented programming system, and applications or programs are located on storage devices, such as hard disk drive 226, and may be loaded into main memory 204 for execution by processing unit 202. The processes for embodiments of the present invention are performed by processing unit 202 using computer usable program code, which may be located in a memory such as, for example, main memory 204, read only memory 224, or in one or more peripheral devices 226 and 230.

Those of ordinary skill in the art will appreciate that the hardware in FIGS. 1-2 may vary depending on the implementation. Other internal hardware or peripheral devices, such as flash memory, equivalent non-volatile memory, or optical disk drives and the like, may be used in addition to or in place of the hardware depicted in FIGS. 1-2. Also, the processes of the present invention may be applied to a multiprocessor data processing system.

In some illustrative examples, data processing system 200 may be a personal digital assistant (PDA), which is configured with flash memory to provide non-volatile memory for storing operating system files and/or user-generated data.

A bus system may be comprised of one or more buses, such as bus 238 or bus 240 as shown in FIG. 2. Of course the bus system may be implemented using any type of communications fabric or architecture that provides for a transfer of data between different components or devices attached to the fabric or architecture. A communications unit may include one or more devices used to transmit and receive data, such as modem 222 or network adapter 212 of FIG. 2. A memory may be, for example, main memory 204, read only memory 224, or a cache such as found in north bridge and memory controller hub 208 in FIG. 2. The depicted examples in FIGS. 1-2 and above-described examples are not meant to imply architectural limitations. For example, data processing system 200 also may be a tablet computer, laptop computer, or telephone device in addition to taking the form of a PDA.

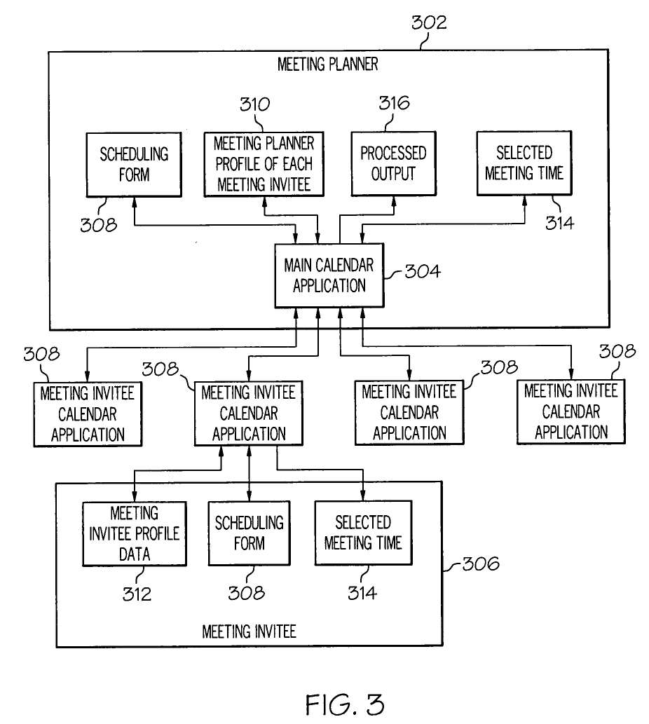

Various inputs are used by the different aspects of the present invention in order to find the best possible meeting time. FIG. 3 is a block diagram that illustrates the manner in which information is managed in accordance with a preferred embodiment of the present invention. Meeting planner 302 has unlimited access to main calendar application 304 which is the master application. Meeting planner 302 uses main calendar application 304 to input information into the system and to send and receive information from meeting invitee 306. The information is preferably displayed by a graphical user interface associated with meeting planner 302 or meeting invitee 306. Meeting planner 302 may use scheduling form 308 for each meeting planned. Scheduling form 308 may include information including: date range, time standard, and estimated meeting duration. Meeting planner 302 selects each meeting invitee 306 that will need to fill out scheduling form 308.

Meeting planner 302 also inputs profile data for meeting invitee 310. Meeting planner profile of each meeting invitee 310 allows meeting planner 302 to indicate certain meeting invitee 306 are necessary parties. Additionally, meeting planner 302 can assign an importance value, and if applicable, an attendance record for meeting invitee 306. The profile may be saved for future use as determined by the meeting planner 302.

Meeting invitee 306 preferably has limited access to main calendar application 304 through meeting invitee calendar application 308 available to all meeting invitees. Meeting invitee calendar application 308 is controlled by main calendar application 304. Meeting invitee calendar application 308 allows meeting invitee 306 to receive scheduling form 308 from meeting planner 302, input meeting invitee profile data 312 and receive selected meeting time 314. Meeting invitee 306 only has access to scheduling form 308 established by meeting planner 302. Meeting invitee 306 may also receive information about selected meeting time 314 through meeting invitee calendar application 308 for planning purposes.

Individual and overall scores as well as all of the other information gathered are available to meeting planner 302 through main calendar application 304 in the form of processed output 316. Processed output 316 is preferably displayed on a graphical user interface for meeting planner 302 to evaluate potential meeting times. Meeting planner 302 may calculate a score for meeting invitee 306 based on information input into the main calendar application by meeting planner 302 and the respective meeting invitee 306. The individual score indicates a likelihood of attendance at a specified time. The sum of the individual scores for each meeting invitee is the overall score. The overall score indicates the overall likelihood of attendance by all meeting invitees. Meeting planner 302 uses processed output 316 to select a meeting time that is then scheduled by passing selected meeting time 314 to main calendar application 304 for distribution to meeting invitee 306.

In one embodiment, meeting invitee calendar application 308 is a limited version of main calendar application 304. In another embodiment, meeting invitee calendar application 308 exchanges limited information with main calendar application 304 as specified by meeting planner 302. The program applications in FIG. 3 may be implemented, stored, and accessed in a network configuration, such as server 104, storage 108, and client 116 shown in FIG. 1.

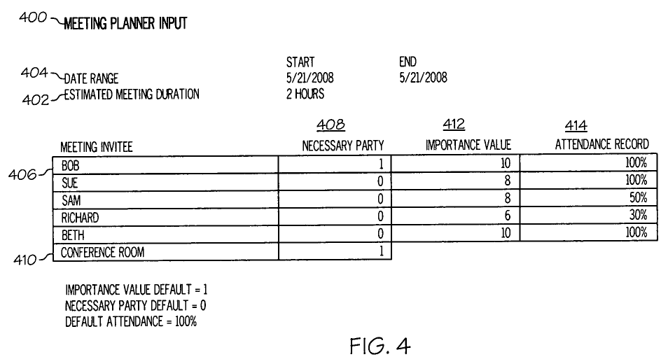

FIG. 4 depicts an example screen of display for receiving meeting planner input 400 in a meeting optimization environment in accordance with an illustrative embodiment of the present invention. The meeting planner may input an estimated meeting duration 402 to better evaluate available times. The meeting planner may also input specific date range 404 during which the meeting may occur. Date range 404 specifies both days and hours within the date range as deemed necessary by the meeting planner. Date range 404 and estimated meeting duration 402 are made available to the meeting invitees as they input their information.

A meeting planner profile is created for each invitee in these illustrative examples. For example, Bob 406 has various values assigned to him by the meeting planner. The meeting planner may rank the importance of the invitee's attendance at the meeting. Some personnel, such as managers, supervisors, or other parties that are necessary or necessary to the success of the meeting may be designated a necessary party 408.

Necessary party 408 is assigned a binary value. A one may indicate that the meeting invitee is necessary party 408 and a zero may indicate that the invitee is not necessary party 408. By default an invitee is not considered necessary party 408 unless specified otherwise. In other words, necessary invitees are in effect “show stoppers”. If that invitee is unable to attend at a specific time, the meeting cannot be held at that time regardless of the availability of other invitees. This feature of the present invention allows the meeting planner to be assured that a meeting will only be held at a time when necessary parties 408 can be present.

In many instances, certain parameters of the meeting cannot change. For example, it may be necessary for a meeting to be held in a specific office or use specific resources, such as teleconferencing equipment. The use of conference room 410 also may be considered a necessary party 408. For example, if a meeting can only be held in a large conference room, such as conference room 410, and that room is only available during certain times of the day due to other meetings or other constraints, the meeting can only be planned at a time when conference room 410 is available.

Each invitee also is assigned a numerical value between negative ten and ten. Importance value 412 correlates to a ranking or relative importance of attendance. Often, a natural division of importance that a meeting planner can assign each invitee is present. Many invitees give relevant and necessary feedback, input, or other information that helps the meeting progress as needed. A meeting planner is likely to assign such individuals a higher importance value 412. Other individual invitees may actually be known for their lack of meeting communication skills and tendency to disrupt or make a meeting ineffective. As a result, the meeting planner may effectively exclude or try to exclude that person from a meeting where possible based on importance value 412 that may actually be negative.

When importance value 412 is a negative ten, this value means that the meeting planner wants to try and make sure that the invitee cannot attend. A zero value for importance value 412 means that the specified individual's attendance neither hurts nor benefits the meeting, and a positive ten means that it is extremely important that the specified invitee attends the meeting. The default value in these examples, if not input by the meeting planner, may be a one. In the event that necessary parties 408 are not present, each invitee may be, by default, assigned importance value 412 of one so that a meeting would be scheduled according to the available time of all parties involved without preference.

In addition to ranking importance value 412 of each individual, the meeting planner may also input information as to how statistically likely that a specific invitee will attend the meeting. Attendance record 414 is likely based on the meeting planner's knowledge of the parameters, such as for example, the invitee's workload, tendencies, personality, and any other relevant information. Attendance record 414 default value, if not input by the meeting planner, will be 100 percent. The default value assumes that the invitee will always come to a planned meeting. Many invitees will commit to coming to a meeting, but then fail to show up. As a result, a meeting planner can statistically rank how likely it is that a person will show up in general or at a specific time based on the previous history of the individual.

For example, some individuals that are extremely busy may often commit to coming to meetings but fail to show up roughly half of the time. The meeting planner could input 50 percent as that person's attendance record 414. Attendance record 414 also may be linked to specific time periods. For example, the meeting planner may know that an individual is only likely to attend approximately 1 in 3 meetings scheduled after 4:00 p.m. As a result, the meeting planner may input attendance record 414 of 30 percent for that invitee for those time periods.

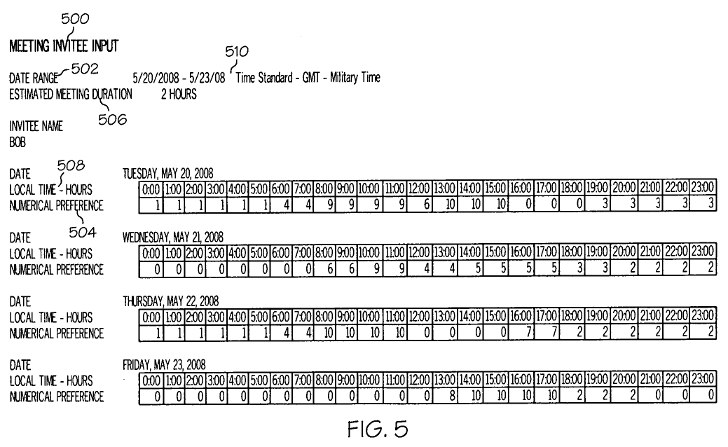

FIG. 5 depicts an example screen of display for receiving input from a meeting invitee in a meeting optimization environment in accordance with an illustrative embodiment of the present invention. In the present invention the meeting planner receives meeting invitee input 500 from each individual invitee. Meeting invitee input 500 may be received through the graphical user interface by filling in various fields as described below.

The meeting invitee specifies whether the meeting invitee is available for each time increment within a specified date range 502 by indicating numerical preference 504. The meeting invitee is provided with estimated meeting duration 506 for judging the approximate length of a proposed meeting. Numerical preference 504 is associated with a time increment in the provided date range 502. In the provided example, the time increment used in these illustrative examples is hours. Depending on the implementation, other increments may be used. For example, the increment may be in minutes or 15 or 30 minute increments for providing more specific times of availability. This smaller size for the increments is especially useful for meetings of shorter duration.

In many cases, a meeting must be held regardless of the inconvenience to and purported unavailability of the meeting invitees. A meeting invitee may input their numerical time preferences 504 based on local time 508 for the meeting invitee. The graphical user interface may display the invitee's local time 508 and time standard 510 which may include a time zone standard and measurement scale upon which a meeting time will be scheduled. In another embodiment, the user may provide a ranking for multiple time increments grouped as a time period rather than each hour. For example, the user could simply specify the user is not available between 12 a.m. to 6:00 a.m. rather than each individual hour between 12 a.m. and 6 a.m.

In some cases, a meeting planner requires a profile of all preferred times over a date range 502 of days, weeks, or in some instances, months. As a result, the invitee inputs numerical preference 504 for each time increment of the day within the specified date range 502. This type of input may be especially useful when a meeting planner has to schedule multiple meetings or a series of progressive meetings. In other cases, the meeting planner may provide a date range 502 limited by a time range or hours during which a meeting could be held on those dates. These times may include, for example, non-work hours and other times that may be altogether inconvenient for different meeting invitees.

Numerical preference 504 may be ranked from zero to ten. With this ranking system, a zero means that the invitee will not be able to attend and a ten means that the invitee will definitely be able to attend. This ranking system allows the meeting planner to choose from a variety of times within date range 502 in order to effectively plan a single or multiple meetings with maximum possible attendance. In some cases, a meeting time may have to be planned even though it is not preferable, but acceptable to most meeting invitees.

In these examples, numerical preference 504 is preferably associated with a numerical likelihood that the invitee will be able to attend and/or preference for having the meeting at that time of the day. A meeting invitee that thinks that an 80 percent chance is present as to whether the invitee will be able to attend at a specified time will input an 8. If the meeting invitee thinks it does not look good and is only 30 percent likely to be able to attend, the invitee will input a 3. In another embodiment, numerical preference 504 entered may be a percentage based on the likelihood of attendance as described above.

Use of numerical preference 504 allows each invitee to schedule out times that are unavailable due to family responsibilities, prior commitments, and normal events, that may include eating, sleeping, and cultural or religious activities. A meeting invitee may schedule unavailable, times because the meeting invitee is unwilling or unable to participate at that time by inputting a zero into numerical preference 504 for a specified time increment. For example, an invitee may specify that 12 a.m. to 4:00 a.m. is a time period that is designated for sleeping regardless of work obligations or potential meetings by inputting zeros for time increments within that period.

Preferably each meeting planner will provide the meeting invitees some guidelines for selecting numerical preference 504 so that there is uniformity in designating numerical preference 504 among the meeting invitees. This information may also be displayed to the meeting invitee by the graphical user interface.

The meeting invitee may store standard information regarding his or her profile including reoccurring work schedule, meetings, and other information used to make decisions as described above. This allows the invitee to quickly edit information for date range 502 without starting from scratch. The information communicated to the meeting invitee may be input, received, and stored in conjunction with a calendar application such as meeting invitee calendar application 308 of FIG. 3.

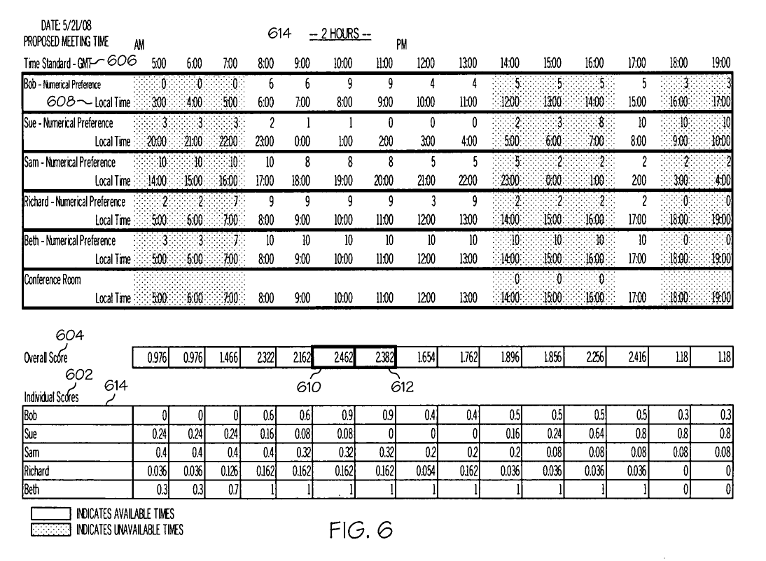

FIG. 6 depicts an example screen of display for maximizing meeting attendance according to an individual score and overall score in a meeting optimization environment in accordance with an illustrative embodiment of the present invention. The input from the invitee and from the planner is compiled to create individual score 602 for each invitee. Individual score 602 is indicative of the likelihood that a specific individual will attend a meeting at any given time. Individual score 602 is dynamic as it may vary from high to low for each hour within a 24-hour period.

Individual score 602 is calculated in these examples by multiplying the importance value assigned by the meeting planner by the numerical preference indicated by the invitee. This value is then divided by 100 to obtain a scaled value between 0 and 1. For example, if Bob is assigned an importance value of 10 and his numerical preference is 6 for a time increment, 10 multiplied by 6 equals 60, divided by 100 equals an individual score 602 of 0.6 for that time increment. In another example, if Peter is assigned an importance value of −6 and his numerical preference for a time is 5, his individual score 602 would be −0.3.

If the meeting planner elects to use attendance records, the calculation of individual score 602 is the same except the attendance record also is multiplied by the importance value and numerical preference. For example, if Sam is assigned an importance value of 8, has a numerical preference of 8 for a time increment, and has been assigned an attendance record of 50 percent by the meeting planner; his individual score will be 0.32 for that time increment.

The meeting planner may chose a time based on many factors including, individual score 602 and series of overall scores 604. Each overall score is the sum of all possible invitee's scores for the specified time increment within the specified date range. It is possible that series of overall score 604 may vary greatly within time increments falling within the specified meeting duration because of each individual's availability and numerical preference. This illustrative embodiment allows the planner to automatically or selectively choose a meeting time in order to maximize the number of invitees or specific invitees that attend. The higher the value for series of overall scores 604, the greater the likelihood that more invitees will attend the meeting. In selecting a meeting time, the meeting planner may also choose a time in order to maximize individual score 602 for an individual or for multiple meeting invitees.

The different illustrative embodiments of the present invention function may be based on a global time scale. As a result, time standard 606 may be used when choosing a meeting time. In some instances, the meeting planner will want to use a standard, such as Universal Time (UT) otherwise known as Greenwich Mean Time (GMT). Additionally, because many users may be located in different time zones, it may be beneficial to present times in military format to clearly identify a.m. and p.m. for the invitees and the meeting planner.

In some cases, time standard 606 will be the local time of the meeting planner. The meeting planner could elect to base the decision making process and times available on a different time zone and time standard 606. For example, if the meeting planner wants to ensure that the scheduling is performed based on the time in the home office of New York, the meeting planner may set time standard 606 as Eastern Standard Time. The meeting planner might actually be based in Hong Kong at GMT+8 hours, but might schedule the meeting time with the home office in New York based on Eastern Standard Time. The different illustrative embodiments of the present invention shows potential meeting times based on time standard 606, but may also display local time 608 and date of relevant meeting invitees.

Once the inputs are received from the meeting invitees and the meeting planner, the information may be processed at the meeting planner's request. This processing may include, for example, the calculation of individual scores 602 and series of overall scores 604 as well as processing the rest of the information to be displayed. The information is then made available to the meeting planner through the graphical user interface. In one depicted embodiment, the present invention provides an automatically generated list of potential meeting times based on score, availability of invitees, and estimated meeting duration. These times may be presented in order of highest overall scores 610, 612 for each time increment in which a meeting could be held based on estimated meeting duration. In another embodiment, the meeting planner is presented with individual scores 602 of each meeting invitee indicating that invitee's likelihood of attendance. For example, Bob's individual scores 614 shows his score for each time increment displayed. This type of presentation allows the meeting planner to get a quick feel for feasible meeting times with the highest overall scores 610, 612 to optimize attendance.

Additionally, the information may be sorted according to individual score, multiple individual's scores, date, time of day, or any of the other inputs of the meeting invitee or meeting planner or a combination thereof. For example, the meeting planner may request the highest overall scores for a specific day be shown.

The display preferably shows time standard 606 for the meeting as well as local meeting time 608 of each individual involved so that the meeting planner can understand the implications of selecting a potential meeting time. For example, a meeting may be at 5 p.m. on July 23^{rd} for New York invitees, but 5 a.m. July 24^{th} in Hong Kong.

In another illustrative embodiment, the meeting planner may elect to personally select a time using the processed information. The meeting planner may do this anytime before or after automatically generating suggested meeting times. The meeting planner may also elect to skip automatically generating meeting times altogether. The graphical user interface preferably allows the user to slide sliding graphical indicator 614 of the meeting duration over times within the date range. An overall score may be displayed for each time increment indicated by sliding graphical indicator 614. Sliding graphical indicator 614 is especially useful because the meeting planner can see individual scores 602 and how they affect series of overall scores 604.

The meeting planner does not have to select a meeting time based on series of overall scores 604 or individual scores 602 if the meeting planner does not make such a selection. “Manual” selection of a meeting time allows the meeting planner to factor in intangible information that is not easily quantified or measured such as, for example, experience with previous meetings, and company culture.

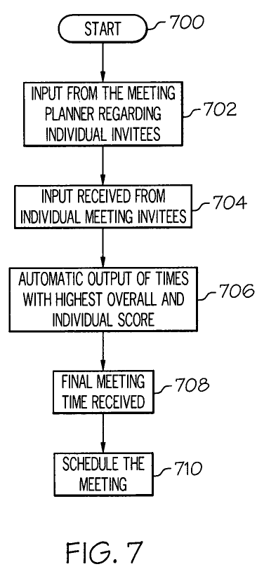

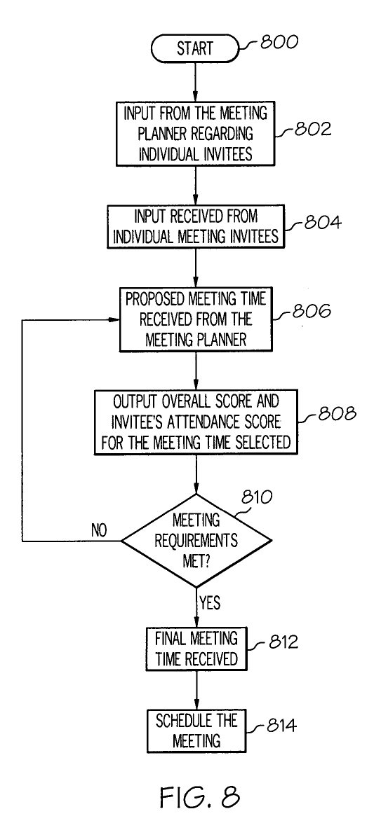

FIG. 7 is a flowchart illustrating exemplary steps for a computer implemented method and computer usable code for efficient optimization of a meeting time selection in accordance with an illustrative embodiment of the present invention. The process illustrated in FIG. 7 may be implemented in a calendar application, such as main calendar application 304 and meeting invitee calendar application 308 in FIG. 3.

Initially the software is opened or accessed to start planning (step 700). The process receives information regarding the individual invitees input by meeting planner (step 702). This received information may include designating the invitee as a necessary party, assigning the invitee an importance value and attendance record, establishing a date range, and estimating a meeting duration. Each individual meeting invitee is requested to input profile information (step 704). This information preferably includes time availability and numerical preference for each time increment within a specific date range. The invitee is able to view the date range and estimated meeting duration when inputting his information using the graphical interface.

The process then processes the information to generate an automatic output of times with the highest overall and individual scores (step 706).

Based on this information, the meeting planner may make a decision regarding a meeting time. The final meeting time is received from the meeting planner (step 708). The meeting is scheduled with the meeting invitees (step 710). The meeting schedule may be available through the program of the present invention. Additionally, the meeting planner may communicate the time with the invitees in whatever manner deemed appropriate.

FIG. 8 is a flowchart illustrating exemplary steps for a computer implemented method and computer usable code for efficient optimization of a meeting time selection in accordance with an illustrative embodiment of the present invention. The process illustrated in FIG. 8 may be implemented in a calendar application, such as main calendar application 304 and meeting invitee calendar application 308 in FIG. 3.

In this embodiment, the process starts (step 800) in the same way by receiving input from the meeting planner (step 802). Input is also received from the meeting invitees (step 804). The meeting planner may then use the processed information to manually select a meeting time. A proposed meeting time may be received from the meeting planner (step 806).

Based on that meeting time, the program outputs the overall score and invitee's attendance scores for the meeting time selected (step 808). The scores are output and displayed so that the meeting planner can see the score for each time increment of the meeting duration within the proposed meeting time.

At that point, a determination is made as to whether the meeting requirements are met (step 810) for the proposed meeting time. In this example, the determination in step 810 is made using input from the meeting planner. This determination is a decision the meeting planner makes based on all of the entered information and additional factors. If the meeting requirements have been met, the meeting planner may make a decision regarding a meeting time. The final meeting time is received from the meeting planner (step 812). The meeting is scheduled with the meeting invitees (step 814). The meeting schedule may be available through the program of the present invention (step 814). Additionally, the meeting planner may communicate the time with the invitees in whatever manner deemed appropriate.

If the meeting requirements are not met (step 810), the meeting planner may reevaluate the information to chose a different time. A proposed meeting time may be received from the meeting planner (step 806) and the process may be repeated until the meeting requirements are met (step 810). Once the meeting requirements are met (step 810), a final meeting time is received (step 812) and the meeting is scheduled (step 814).

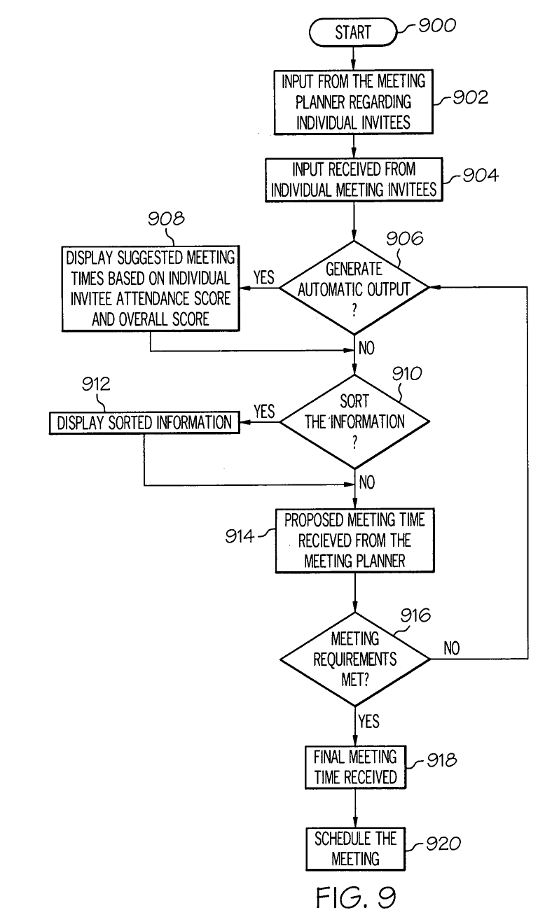

FIG. 9 is a flowchart illustrating exemplary steps for a computer implemented method and computer usable code for efficient optimization of a meeting time selection in accordance with an illustrative embodiment of the present invention. The process illustrated in FIG. 9 may be implemented in a calendar application, such as main calendar application 304 and meeting invitee calendar application 308 in FIG. 3.

In another embodiment of the present invention, the process starts (step 900) in the same way by receiving input from the meeting planner (step 902). Input is also received from the meeting invitees (step 904). At this point, a determination is made as to whether to generate an automatic output (step 906). The automatic output is suggested meeting times. If the user input from the meeting planner is to generate automatic output (step 906), the program displays suggested meeting times based on individual invitee attendance scores and overall score (step 908). A determination is made as to whether the information is to be sorted (step 910).

With reference again to step 906, if the meeting planner decides not to generate an automatic output, a determination is made as to whether the information is to be sorted (step 910). The determination made in step 910 is made based on a user input from the meeting planner in these examples. The meeting planner is also prompted to select to sort the information (step 910) after the meeting planner chooses to generate an automatic output and the suggested meeting times are displayed (step 908). This allows the meeting planner to sort through the program information personally entered and by information entered by the invitees. If the meeting planner selects to sort the information (step 910), the program displays the sorted information (step 912). The meeting planner may then use the sorted information and/or the automatically generated output to manually select a meeting time. A proposed meeting time may be received from the meeting planner (step 914).

If the user input from the meeting planner decides not to sort the information (step 910), a proposed meeting time may be received from the meeting planner (step 914). A determination of whether the meeting requirements have been met (step 916). This determination is user input received from the meeting planner. If the meeting requirements have been met (step 916), the meeting planner may make a decision regarding a meeting time. The final meeting time is received from the meeting planner (step 918). The meeting is scheduled with the meeting invitees (step 920). The meeting schedule may be available through the program of the present invention. Additionally, the meeting planner may communicate the time with the invitees in whatever manner deemed appropriate.

If the meeting requirements are not met (step 916), a determination must be made whether to generate automatic output (step 906). The process is repeated until the meeting requirements are met (step 916). The final meeting time may then be received (step 918) and scheduled (step 920).

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

The software or application embodiment can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

The software may be run by any electronic device including a computer, server, cell phone, personal digital assistant (PDA), or other electronic device capable of executing or accessing a software program. The software is preferably available over a communications network that allows invitees from all over the world to access the software and/or synchronize their copy of the software and corresponding inputs with the meeting planner. This allows the meeting planner to establish information such as a date range, time range, the applicable time standard, and meeting duration for the meeting invitees.

The present invention may be implemented in a data processing system suitable for storing and/or executing program code and will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method of optimizing meeting attendance, the computer implemented method comprising:
receiving input from a plurality of meeting invitees to generate a set of profiles for the plurality of meeting invitees, wherein the input comprises attendance information for each of the plurality of meeting invitees; and
responsive to a selection of a proposed meeting, generating a set of scores for proposed meeting using the set of profiles for the plurality of meeting invitees, wherein the set of scores indicates a likelihood of attendance for each of the plurality of meeting invitees for the proposed meeting.

2. The computer implemented method of claim 1 further comprising:
selecting a range of meeting times for the proposed meeting; and
generating a list of meeting times associated with scores for each meeting time on the list.

3. The computer implemented method of claim 1, wherein the proposed meeting has an estimated meeting duration and a date range.

4. The computer implemented method of claim 3, wherein the input comprises a numerical preference for each time increment within the date range as specified by the plurality of meeting invitees.

5. The computer implemented method of claim 4, wherein the numerical preference is a numerical ranking between zero and ten associated with a meeting invitee's likelihood of attendance, wherein a zero for the numerical ranking indicates the meeting invitee is unavailable at the time increment, wherein a ten associated with the numerical ranking indicates the meeting invitee is available at that time.

6. The computer implemented method of claim 1, wherein the input is received from the plurality of meeting invitees and a meeting planner.

7. The computer implemented method of claim 6, wherein receiving input from the meeting planner further comprises designating each of the plurality of meeting invitees as a necessary party or a non-necessary party.

8. The computer implemented method of claim 6, wherein receiving input from the meeting planner further comprises assigning an importance value, wherein the importance value is a numerically scaled value between −10 and 10, wherein a numerically scaled value of −10 indicates that the meeting planner strongly wants the meeting invitee to not attend and the numerically scaled value of 10 indicates the meeting planner strongly wants the meeting invitee to attend, wherein the numerically scaled value of zero indicates no preference.

9. The computer implemented method of claim 6, further comprising allowing the meeting planner to send and receive the input, the set of profiles, and the scores using a main calendar program application.

10. The computer implemented method of claim 9, further comprising allowing the plurality of meeting invitees to access a portion of the main calendar program application to enter the input.

11. The computer implemented method of claim 1, further comprising allowing the meeting planner to view the set of scores associated with a time increment by sliding a graphical indicator indicative of a meeting duration over the time increments within a date range.

12. The computer implemented method of claim 1, wherein the set of scores further comprises an individual score for each time increment within a date range for the plurality of meeting invitees and an overall score, wherein the overall score is the sum of all individual scores for a specified time increment.

13. The method of claim 12, further comprising suggesting meeting times based on the overall score.

14. The method of claim 12, wherein the individual score is calculated by multiplying an importance value, a numerical preference and an attendance record to obtain a result and dividing the result by 100.

15. A computer program product comprising a computer usable medium including computer usable program code for optimizing meeting attendance, the computer program product including:
computer usable code for receiving input from a plurality of meeting invitees to generate set of profiles for the plurality of meeting invitees, wherein the input comprises attendance information for each of the plurality of meeting invitees; and
responsive to a selection of a proposed meeting, computer usable program code for generating a set of scores for proposed meeting using the set of profiles for the plurality of meeting invitees, wherein the set of scores indicates a likelihood of attendance for each of the plurality of meeting invitees for the proposed meeting.

16. The computer program product of claim 15, wherein the computer usable code for receiving input includes input from the plurality of meeting invitees and a meeting planner.

17. The computer program product of claim 16, wherein the computer usable code for receiving input from the plurality of meeting invitees further comprises designating a numerical preference for each time increment within a specified date range.

18. The computer program product of claim 16, wherein the computer usable code for receiving input from the meeting planner further comprises any of designating each of the plurality of meeting invitees as a necessary party or a non-necessary party, assigning an importance value to the plurality of meeting invitees, designating a time standard, establishing an estimated meeting duration, setting a date range, and assigning an attendance record to the plurality of meeting invitees.

19. A system for maximizing meeting attendance comprising:
one or more databases, associated with one or more servers, which stores input from a plurality of meeting invitees to generate set of profiles for the plurality of meeting invitees, wherein the input comprises attendance information for each of the plurality of meeting invitees; and
one or more user workstations connected over a network to the servers and further comprising a processor, a memory, and a display wherein the set of profiles are temporarily stored in the memory of the one or more workstation and processed by the processor to display a set of scores on the display which indicate a likelihood of attendance for each of the plurality of meeting attendees for the proposed meeting.

20. The system of claim 19, wherein only a meeting planner can access the set of profiles for the plurality of meeting invitees.
